(19) United States
(12) Patent Application Publication
(10) Pub. No.: US 2015/0014100 A1
(43) Pub. Date: Jan. 15, 2015

(54) ELEVATOR GOVERNOR AND ELEVATOR DEVICE

(71) Applicant: Takeshi Niikawa, Tokyo (JP)

(72) Inventor: Takeshi Niikawa, Tokyo (JP)

(73) Assignee: Mitsubishi Electric Corporation, Chiyoda-ku, Tokyo (JP)

(21) Appl. No.: 14/370,122

(22) PCT Filed: Mar. 6, 2012
(86) PCT No.: PCT/JP2012/055641

§ 371 Date: Jul. 1, 2014

(51) Int. Cl. B66B 5/04

(52) U.S. Cl. CPC B66B 5/046
USPC 187/287

(57) ABSTRACT

An elevator governor to actuate an emergency stop device when a car descends, with a door kept open, includes: a pendulum which moves to a radially outer side of a sheave based on rotational speed of the sheave; a rope constraining mechanism which constrains a governor rope when the pendulum has moved when the car is descending; a protruding body provided in the pendulum; a cam, controlled by a cam moving mechanism, configured to move between a protruding position to contact the protruding body and a retracted position to not contact the protruding body, when the car door is open. A cam surface, when the cam is in the protruding position, moves the pendulum to the radially outer side of the sheave over a moving distance, and the cam moving mechanism moves the cam to the protruding position in the process of movement of the cam.

### TECHNICAL FIELD

The present invention relates to an elevator governor and an elevator device.

### BACKGROUND ART

There is known a conventional elevator governor which is provided with a sheave on which a governor rope for actuating an emergency stop device and which rotates according to the ascent and descent speed of a car, a fly-weight which is rotatably attached to the sheave and is caused to move around by the centrifugal force due to the rotation of the sheave, a spring which urges the fly-weight in the direction in which the fly-weight resists the above-described centrifugal force, a ratchet provided so as to be rotatable about a sheave shaft of the sheave, a latch portion which is provided in the fly-weight, engages with the ratchet when the descent speed of the car has reached a predetermined overspeed, and rotates the latchet in the same direction as the sheave, and a shoe which controls the governor rope when the latchet rotates (refer to Patent Literature 1, for example).

There has hitherto been known also an elevator governor which is provided with a speed governing rope which performs circulating movement in synchronization with ascent and descent of a car, an emergency stop device which is provided in a car by being connected to the speed governing rope and goes into action when the speed governing rope is pulled up with respect to the car, thereby grasping a guide rail to stop the descent of the car, and a governor which, in the case where a condition in which the car is descending at a speed higher than a predetermined speed has been detected, actuates the emergency stop device by controlling the speed governing rope, thereby stopping the descent of the car. The above-described governor grasps the speed governing rope when an open condition of a car door of the car has been detected and prevents the descent of the car by actuating the emergency stop device in the case where the car has descended (refer to Patent Literature 2, for example).

### CITATION LIST

### Patent Literature

Patent Literature 1: Japanese Patent No. 4437574
Patent Literature 2: Japanese Patent Laid-Open No. 2009-173429

### SUMMARY OF INVENTION

### Technical Problem

As described above, the conventional elevator governor described in Patent Literature 1 actuates the emergency stop device by constraining the speed governing rope when the descent speed of the car has reached a predetermined overspeed (an emergency action speed). On the other hand, in the case where the car has begun an unexpected descent at a service floor, with the door kept open, due to an abnormality in a traction machine brake and the like, it is necessary to stop the car within a predetermined distance.

However, within this predetermined distance, in some cases there is the possibility that the descent speed of the car does not reach the emergency stop action speed. Therefore, this conventional elevator governor has the problem that the elevator governor cannot be used to prevent the descent of the car when the car is at a service floor, with the door kept open.

In contrast to this, in the conventional elevator governor described in Patent Literature 2, in the case where the car door is kept open, the roller of a fly-weight (a pendulum) is pressed by an operating lever and the governor is brought into the same condition as when the descent speed of the car has reached the emergency stop actuation speed, whereby in the case where the car has descended in this condition, it is possible to actuate the emergency stop device by grasping the governor rope.

However, usually, when a user boards a car, sinking (descending) of the car may sometimes occur to some extent. In the elevator governor described in Patent Literature 2, in the case where the roller of the fly-weight (pendulum) is just in a position where the fly-weight (pendulum) is pressed by the operating lever when the car door is opened, even a slight amount of descent of the car causes the governor rope to be grasped, leading to the actuation of the emergency stop device. That is, this conventional elevator governor has the problem that in this case, there is the possibility that the emergency stop device malfunctions even due to the sinking (descending) of the car to such an extent that can usually occur when a user boards a car.

The present invention was made in order to solve the above-described problem and the object of the present invention is to obtain an elevator governor and an elevator device which are capable of appropriately actuating an emergency stop device by preventing malfunctions of the emergency stop device in the case where the descent of a car occurs during the opening of a door.

### Means for Solving the Problems

An elevator governor according to the present invention, which has a governor rope which performs circulating movement in synchronization with ascent and descent of a car disposed in a shaft of an elevator in such a manner as to be capable of ascending and descending and a sheave on which the governor rope is wound and which rotates in synchronization with the ascent and descent of the car via the governor rope, and constrains the circulating movement of the governor rope in a case when the descent speed of the car has reached a predetermined speed, comprises: a pendulum which is provided in the sheave, rotates integrally with the sheave, and moves to a radially outer side of the sheave according to the rotational speed of the sheave; rope constraining means which constrains the circulating movement of the governor rope when the pendulum has moved over a moving distance which is not less than a predetermined moving distance to the radially outer side of the sheave when the car is descending; a cam contact portion which is provided in the pendulum and moves integrally with the pendulum with respect to the sheave; a cam which is provided in such a manner as to be capable of moving between a protruding position where the cam can come into contact with the cam contact portion and a retracted position where the cam cannot come into contact with the cam contact portion; and cam moving means which moves the cam from the retracted position to the protruding position when the car door is open, wherein the cam has a cam surface which is formed in such a manner that, in the case where the cam is in the protruding position, the cam surface guides the cam contact portion of the pendulum which rotates integrally with the sheave in the direction in which the car descends, and moves the pendulum to the radially outer side of the sheave over a moving distance which is not less than the predetermined moving distance, and wherein the cam moving means moves the cam to the protruding position from the direction in which the cam contact portion and the pendulum are not moved to the radially outer side of the sheave in the process of movement of the cam.

Also, an elevator device according to the present invention comprises: the above-mentioned elevator governor; and an emergency stop device which is provided in the car and stops the car by coming into action in a case where the governor rope is pulled up with respect to the car.

### Advantageous Effect of Invention

The elevator governor and elevator device of the present invention produce the effect that it is possible to appropriately actuate an emergency stop device by preventing malfunctions of the emergency stop device in the case where the descent of a car occurs during door opening.

### BRIEF DESCRIPTION OF THE DRAWINGS

FIG. 1 is a schematic diagram showing the general configuration of an elevator device provided with an elevator governor relating to Embodiment 1 of the present invention.

FIG. 2 is a front view of the elevator governor relating to Embodiment 1 of the present invention.

FIG. 3 is a side view of the elevator governor relating to Embodiment 1 of the present invention.

FIG. 4 is a perspective front view showing the main part of the elevator governor relating to Embodiment 1 of the present invention.

FIG. 5 is an enlarged view of the main part as seen from the direction of the arrow of A of FIG. 4, relating to Embodiment 1 of the present invention.

FIG. 6 is a diagram to explain the movement of a cam by the energization of a solenoid coil in FIG. 5, relating to Embodiment 1 of the present invention.

FIG. 7 is the first diagram to explain actions of the elevator governor during an elevator run relating to Embodiment 1 of the present invention.

FIG. 8 is the second diagram to explain actions of the elevator governor during an elevator run relating to Embodiment 1 of the present invention.

FIG. 9 is the third diagram to explain actions of the elevator governor during an elevator run relating to Embodiment 1 of the present invention.

FIG. 10 is the fourth diagram to explain actions of the elevator governor during an elevator run relating to Embodiment 1 of the present invention.

FIG. 11 is the first diagram to explain actions of the elevator governor when the door is kept open relating to Embodiment 1 of the present invention.

FIG. 12 is the second diagram to explain actions of the elevator governor when the door is kept open relating to Embodiment 1 of the present invention.

FIG. 13 is the third diagram to explain actions of the elevator governor when the door is kept open relating to Embodiment 1 of the present invention.

FIG. 14 is the fourth diagram to explain actions of the elevator governor when the door is kept open relating to Embodiment 1 of the present invention.

FIG. 15 is a front view showing the condition in which the movement of the cam is prevented by the pin of a pendulum of the elevator governor relating to Embodiment 1 of the present invention.

FIG. 16 is an enlarged view of the main part as seen from the direction of the arrow of B of FIG. 15, relating to Embodiment 1 of the present invention.

FIG. 17 is a front view of an elevator governor relating to Embodiment 2 of the present invention.

### DESCRIPTION OF EMBODIMENTS

The present invention will be described with reference to the accompanying drawings. In each of the drawings, identical numerals refer to identical or corresponding parts and overlaps of description of these parts are appropriately simplified or omitted.

### Embodiment 1

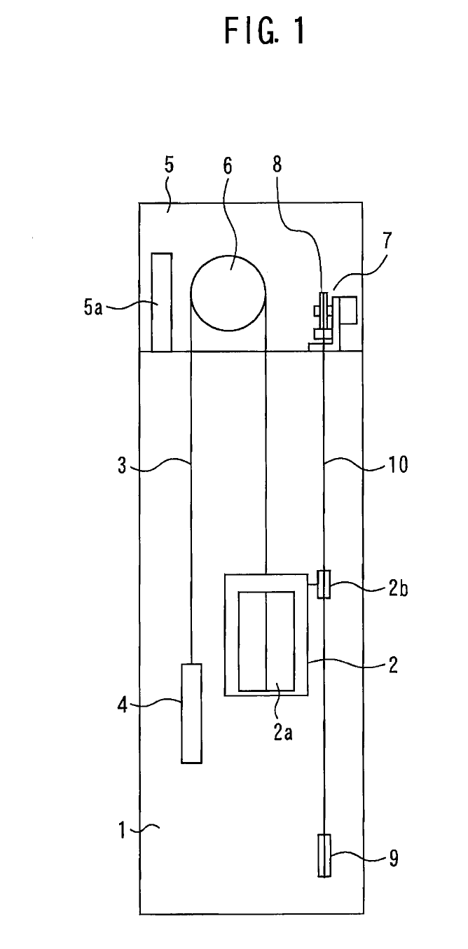

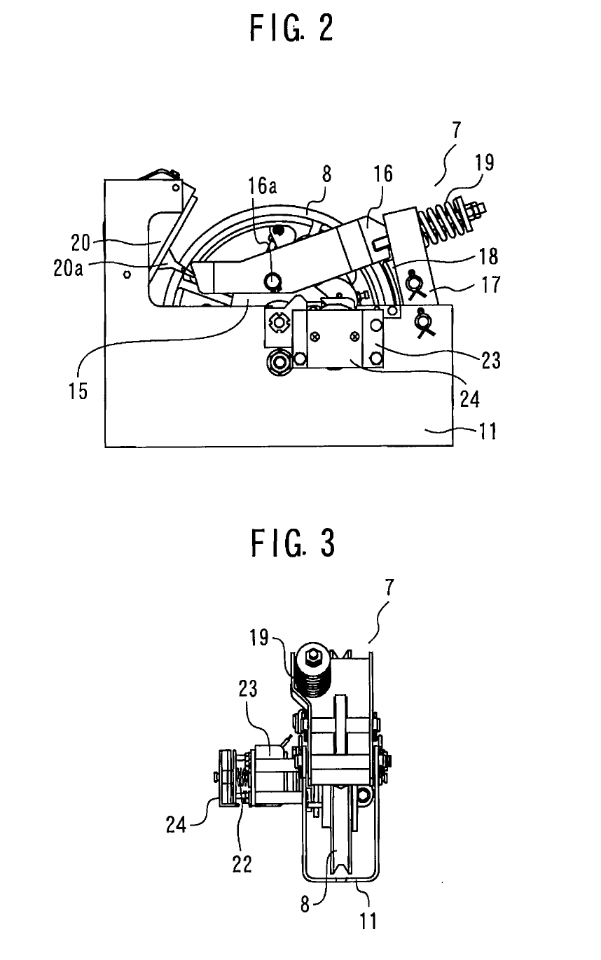

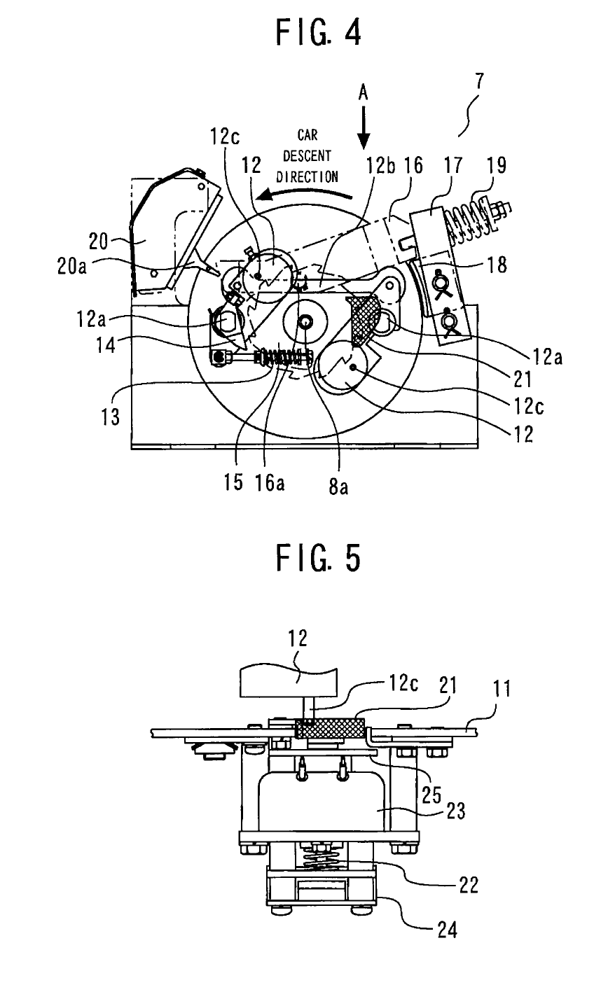

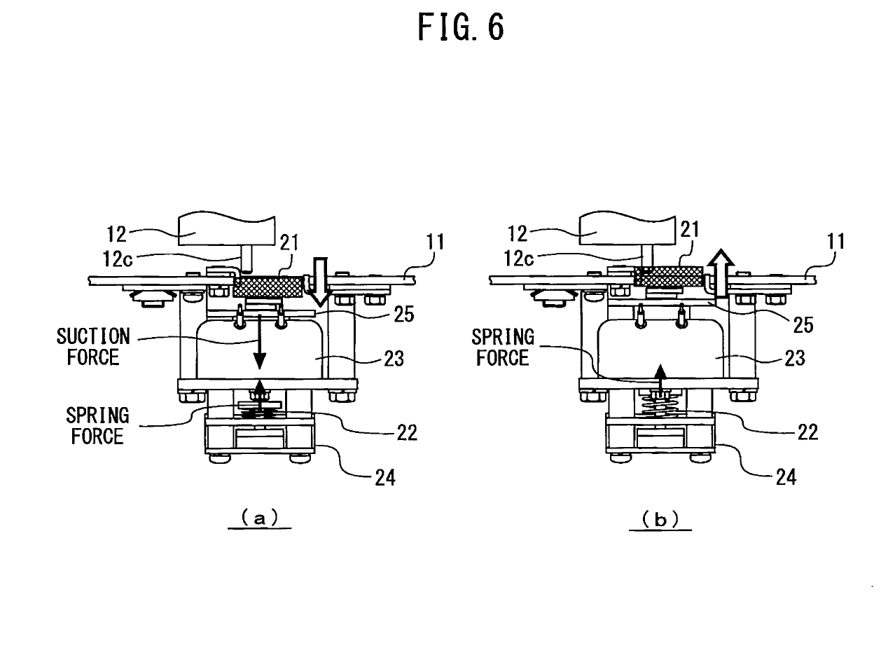

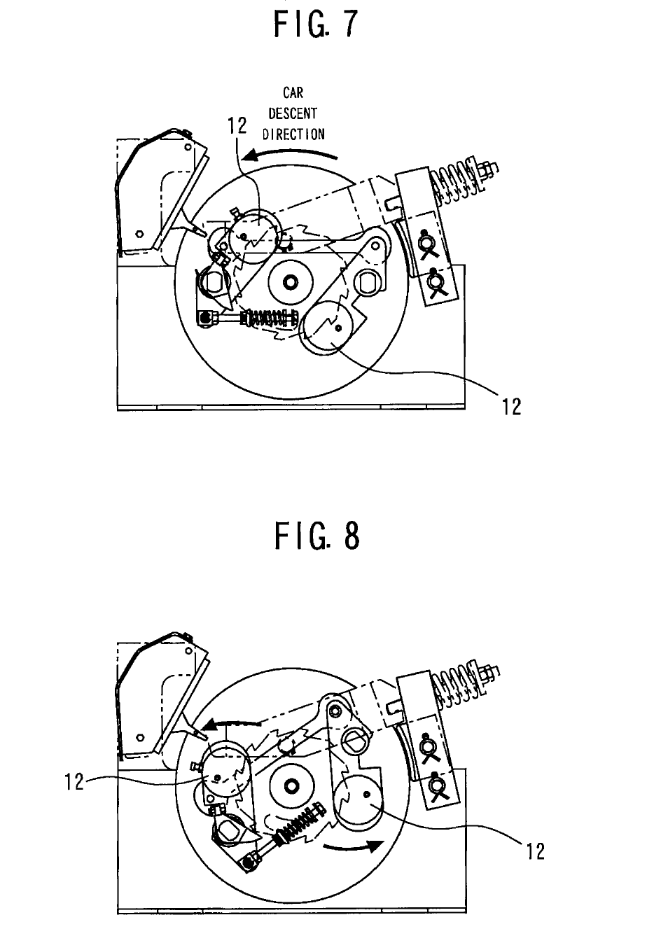

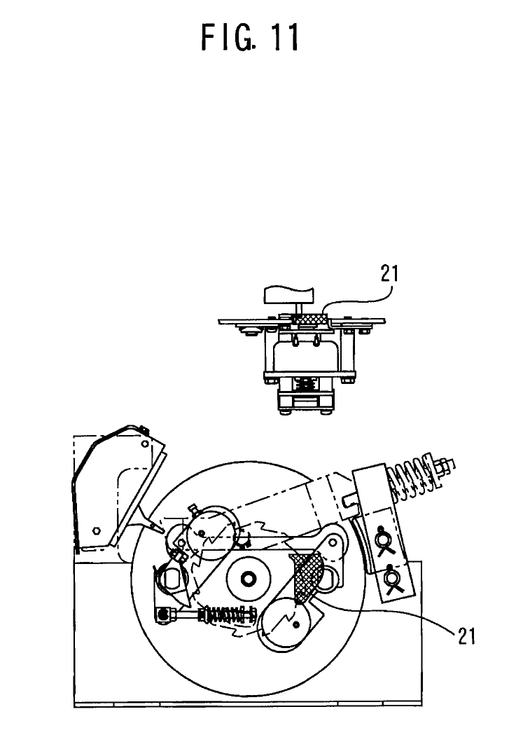

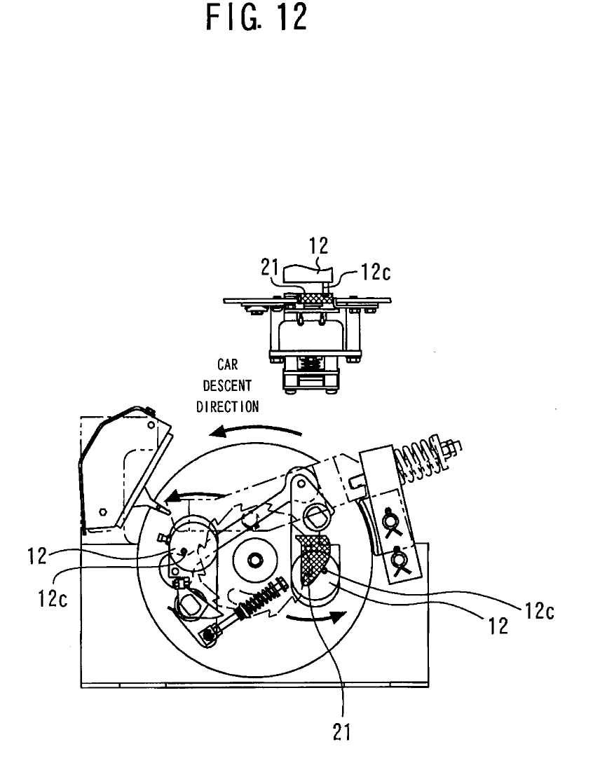

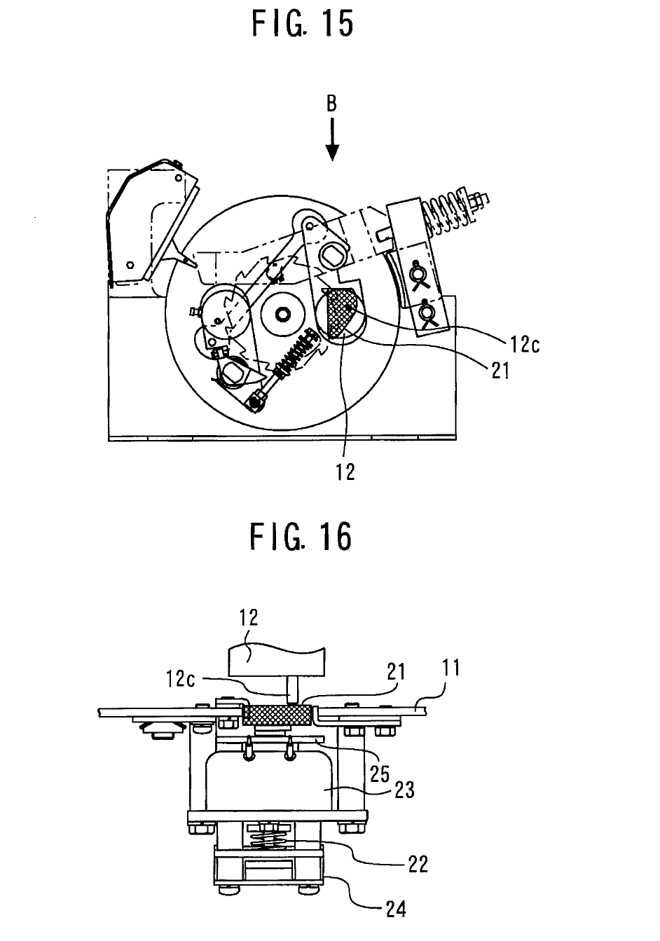

FIGS. 1 to 14 relate to Embodiment 1 of the present invention. FIG. 1 is a schematic diagram showing the general configuration of an elevator device provided with an elevator governor. FIG. 2 is a front view of the elevator governor. FIG. 3 is a side view of the elevator governor. FIG. 4 is a perspective front view showing the main part of the elevator governor. FIG. 5 is an enlarged view of the main part as seen from the direction of the arrow of A of FIG. 4. FIG. 6 is a diagram to explain the movement of a cam by the energization of a solenoid coil in FIG. 5. FIGS. 7 to 10 are diagrams to explain actions of the elevator governor during an elevator run. FIGS. 11 to 14 are diagrams to explain actions of the elevator governor when the door is kept open. FIG. 15 is a front view showing the condition in which the movement of the cam is prevented by the pin of a pendulum of the elevator governor. And FIG. 16 is an enlarged view of the main part as seen from the direction of the arrow of B of FIG. 15.

In FIG. 1, reference numeral 1 denotes a shaft which is provided in a standing manner in a building where an elevator is installed. In this shaft 1, a car 2 which ascends and descends, with users, baggage and the like loaded thereon, is disposed. One end of a main rope 3 is connected to the upper end of this car 2, and the other end of this main rope 3 is connected to the upper end of a counterweight 4. And the middle part of the main rope 3 is wound on a driving sheave of a traction machine 6 installed in a machine room 5 provided at the top part of the shaft. In this manner, the car 2 and the counterweight 4 are hung by the main rope 3 like a well bucket capable of ascending and descending in the directions opposite to each other in the shaft.

An entrance provided at the front of the car 2 is provided with a car door 2a which opens and closes this entrance. The whole operation of an elevator, including the ascent and descent actions of the car 2 and door opening and closing actions, is controlled by a control panel 5a installed in the machine room 5.

A governor 7 is installed in the machine room 5, and a sheave 8 is provided in this governor 7 in such a manner as to be capable of rotating in both directions. Also, a governor tension sheave 9 is provided in the lower part of the shaft 1 in such a manner as to be capable of rotating in both directions, and a governor rope 10 is wound in an endless manner on the sheave 8 of the governor 7 and the governor tension sheave 9.

This governor rope 10 is locked to the car 2 in an engaged state via an arm portion 2b, the governor rope 10 goes around as the car 2 ascends and descends, and the sheave 8 rotates. The rotational speed of the sheave 8 on this occasion is determined according to the ascent and descent speed of the car 2. That is, the higher the ascent and descent speed of the car 2, the higher the rotational speed of the sheave 8; the lower the ascent and descent speed of the car 2, the lower the rotational speed of the sheave 8. Furthermore, the rotational direction of the sheave 8 is determined by whether the car 2 is ascending or descending.

Although here, the above description was given by taking the case where the machine room 5 is located at the top of the shaft 1 as an example, the present invention may be applied to what is called a machine-room-less elevator in which there is no machine room 5. In the case of a machine-room-less elevator, the control panel 5a, the traction machine 6, and the governor 7 are disposed in predetermined positions in the shaft 1.

Next, the configuration of the governor 7 will be described with reference to FIGS. 2 to 5. The sheave 8 of the governor 7 is supported by a frame 11 via a sheave shaft 8a provided at the center of the sheave 8. A pair of pendulums 12 is attached to one side surface of the sheave 8. These pendulums 12 provided in a pair are attached to one side surface of the sheave 8 via a pendulum shaft 12a each at a point near one end of the sheave 8. Each of the pendulums 12 can swing around each of the sheave shafts 12a.

These pendulums 12 provided in a pair are disposed in positions symmetrical with respect to the sheave shaft 8a. And these pendulums 12 are connected by a link rod 12b so that the swings of these pendulums 12 occur in synchronization with each other. Furthermore, in one of the pendulums 12 provided in a pair, there is provided a pendulum spring 13 which urges the pendulum 12 to swing in the direction in which the weight side of the pendulum 12 is caused to approach the sheave shaft 8a.

The pendulums 12 thus provided in a pair are disposed in positions where the weight side of each of the pendulums 12 approaches the sheave shaft 8a to the greatest degree due to the action of the pendulum spring 13 when the car 2 is at a standstill. When the car 2 ascends and descends and the sheave 8 rotates, also the pair of pendulums 12 rotates integrally with the sheave 8. And due to the action of a centrifugal force acting on the weight of the pendulum 12 which occurs as a result of the rotation of the sheave 8, the pendulum 12 will swing around the pendulum shaft 12a of the pendulum 12 in such a manner as to spread to the radially outer side of the sheave 8. However, in actuality, the pendulum 12 does not begin to swing to the radially outer side until the moment which will spread the pendulum 12 to the radially outer side by a centrifugal force exceeds the moment due to the pendulum spring 13 which acts in the direction in which the latter moment resists the former moment.

When the rotational speed of the sheave 8 becomes higher than a predetermined rotational speed, the moment which will spread the pendulum 12 by a centrifugal force to the radially outer side exceeds the moment by the pendulum spring 13 and the pendulum 12 begins to spread to the radially outer side. And the higher the rotational speed of the sheave 8, the larger the centrifugal force acting on the pendulum 12, and the pendulum 12 spreads to the radially outer side of the sheave 8 to a greater extent.

An engaging click 14 is attached to one of the pair of pendulums 12. This engaging click 14 is provided coaxially with the pendulum shaft 12a of this pendulum 12 and is configured to swing integrally with this pendulum 12.

On one side surface of the sheave 8, coaxially with the sheave shaft 8a of the sheave 8, there is provided a ratchet 15 in the shape of a roughly round shape having a ratchet tooth on the outer circumference thereof. Although coaxial, this ratchet 15 and the sheave 8 are configured to be independent from each other and to be able to rotate individually.

It is ensured that when the pendulum 12 provided with the engaging click 14 spreads to the radially outer side of the sheave 8 over a moving distance which is not less than a predetermined moving distance, the engaging click 14 and the ratchet tooth on the outer circumference of the ratchet 15 come into contact with each other. And in the case where the pendulum 12 and the engaging click 14 rotate in the same direction as the rotational direction of the sheave 8 which is obtained during the descent of the car 2, with the engaging click 14 and the ratchet tooth of the ratchet 15 in contact with each other, the engaging click 14 and the ratchet tooth of the ratchet 15 engage with each other, and the pendulum 12, the engaging click 14, and the ratchet 15 rotate integrally.

On the other hand, in the case where the pendulum 12 and the engaging click 14 rotate in the same direction as the rotational direction of the sheave 8 which is obtained during the ascent of the car 2, the engaging click 14 and the ratchet tooth of the ratchet 15 do not engage with each other, with the result that the ratchet 15 does not rotate regardless of the rotation of the pendulum 12 and the engaging click 14.

As described above, the engaging click 14 and the ratchet 15 constitute a latch mechanism, and it is ensured that in the case where the sheave 8 rotates in the direction in which car 2 descends, with the engaging click 14 and the ratchet tooth of the ratchet 15 kept in a contact condition, the ratchet 15 rotates integrally with the sheave 8, and that the ratchet 15 does not rotate in the case where the sheave 8 rotates in the direction in which the car 2 ascends.

A stretch rod 16 is attached to the ratchet 15 by an attaching shaft 16a to the ratchet 15 in the intermediate part of this stretch rod 16. And a shoe lever 17 to which a shoe 18 is attached and a shoe spring 19 are provided at one end of the stretch rod 16. Also, in a position opposed to the other end of the stretch rod 16, a switch lever 20a of an overspeed switch 20 is disposed.

In a normal condition, the shoe 18 is present in a position spaced from the governor rope 10 which is wound on the sheave 8. And as described above, when the ratchet 15 rotates with the sheave 8 which rotates in the direction in which the car 2 descends, the stretch rod 16 is drawn and the shoe lever 17 falls to the sheave 8 side, with the result that the governor rope 10 is grasped by the shoe 18 and the sheave 8. On this occasion, the shoe 18 is pushed to the governor rope 10 by an urging force caused by the shoe spring 19.

Furthermore, when the stretch rod 16 is drawn by the ratchet 15 and moves, the other end of the stretch rod 16 pushes the switch lever 20a of the overspeed switch 20 and the overspeed switch 20 comes into action. An action signal of the overspeed switch 20 is transmitted to the control panel 5a, and control, for example, the stop of the traction machine 6 and the actuation of a brake of the traction machine 6 (not shown), is performed by the control panel 5a.

A cam 21 is provided in the part of the frame 11 opposed to one side surface of the sheave 8 provided with the pendulum 12. This cam 21 is provided in such a manner as to be capable of moving along a direction substantially perpendicular to the side surface of the sheave 8 between the protruding position where the cam 21 protrudes to the sheave 8 side surface and the retracted position where the cam 21 is retracted to the frame 11 side.

This movement of the cam 21 from the protruding position to the retracted position or vice versa is performed by driving a push spring 22 and a solenoid coil 23 which are provided in the frame 11. The push spring 22 and the solenoid coil 23 are disposed on the outer side surface of the frame 11 on the frame 11 side as seen from the cam 21.

The push spring 22 urges the cam 21 in the direction in which the cam 21 is moved from the retracted position to the protruding position. The counter cam 21 side of the push spring 22 is held by a spring holding plate 24. And between the solenoid coil 23 and the cam 21, a solenoid plunger 25 is inserted, and the cam 21 moves integrally with the solenoid plunger 25.

On the cam 21 side of each weight of each of the pendulums 12, a pin 12c is provided in a standing manner substantially perpendicularly to the side surface of the sheave 8. The positional relationship between this pin 12c and the cam 21 and the movement of the cam 21 will be described with reference to FIG. 6.

During the energization of the solenoid coil 23, the force of the solenoid coil 23 which sucks the solenoid plunger 25 exceeds the elastic force of the push spring 22, and the cam 21, along with the solenoid plunger 25 sucked by the solenoid coil 23, moves to the retracted position. When the cam 21 is in the retracted position, the pin 12c of the pendulum 12, which rotates with the sheave 8, and the cam 21 are disposed in positions where the two do not come into contact with each other ((a) of FIG. 6).

On the other hand, when the energization of the solenoid coil 23 is cut off, the cam 21 moves to the protruding position by the elastic force of the push spring 22. When the cam 21 is in the protruding position, the pin 12c of the pendulum 12, which rotates with the sheave 8, and the cam 21 are disposed in positions where the two can come into contact with each other ((b) of FIG. 6). The push spring 22 may directly push the cam 21 or may indirectly push the cam 21 by pushing the solenoid plunger 25.

This movement of the cam 21 between the protruding position and the retracted position is controlled by the control panel 5a in such a manner as to synchronize with the open and closed condition of the car door 2a. Specifically, for example, when the car 2 lands a floor and the car door 2a is opened, the energization of the solenoid coil 23 is cut off by a signal from the control panel 5a and the cam 21 is disposed in the protruding position. On the other hand, when the car door 2a is closed and the car 2 is running, the solenoid coil 23 is energized by a signal from the control panel 5a and the cam 21 is disposed in the retracted position.

For the shape of the cam 21, the cam 21 has a cam surface formed from an inclined surface and/or a curved surface so that, in the case where the sheave 8 and the pendulum 12 rotate in the direction in which the car 2 descends, the pin 12c of the pendulum 12 in the condition in which the pin 12c is nearest to the sheave shaft 8a side runs onto the cam 21 in the protruding position, with the result that the pendulum 12 is forcedly expanded to the radially outer side of the sheave 8.

Furthermore, this cam surface of the cam 21 is formed so that by the running of the pin 12c onto the cam surface of the cam 21, the pendulum 12 is moved to the radially outer side of the sheave 8 up to a position where the engaging click 14 engages with the ratchet 15.

Actions of the elevator governor thus configured during an elevator run will be described with reference to FIGS. 7 to 10. In these drawings, in consideration of the ease with which the drawings are seen, reference numerals of components are omitted.

First, here, the above-described predetermined rotational speed of the sheave 8 at which the pendulum 12 begins to spread by a centrifugal force to the radially outer side is set at a value higher than a rotational speed corresponding to, for example, a rated speed of an elevator. And let us assume that the car 2 runs in the descent direction. The car door 2a is closed during the run of the car 2 and, therefore, the solenoid coil 23 is energized and the cam 21 is disposed in the retracted position.

In this condition, in the case where the descent speed of the car 2 is not more than the rated speed, the pendulum 12, which rotates with the sheave 8, does not begin to swing to the radially outer side of the sheave 8. Furthermore, because the cam 21 is in the retracted position, the pin 12c of the pendulum 12 and the cam 21 do not come into contact with each other, either (FIG. 7).

When the descent speed of the car 2 exceeds the rated speed and increases further, by the centrifugal force acting on the pendulum 12, the pendulum 12 begins to swing to the radially outer side of the sheave 8 (FIG. 8). And when the descent speed of the car 2 reaches a predetermined emergency stop action speed, which is higher than the rated speed, the engaging click 14 of the pendulum 12 comes into contact with the ratchet 15.

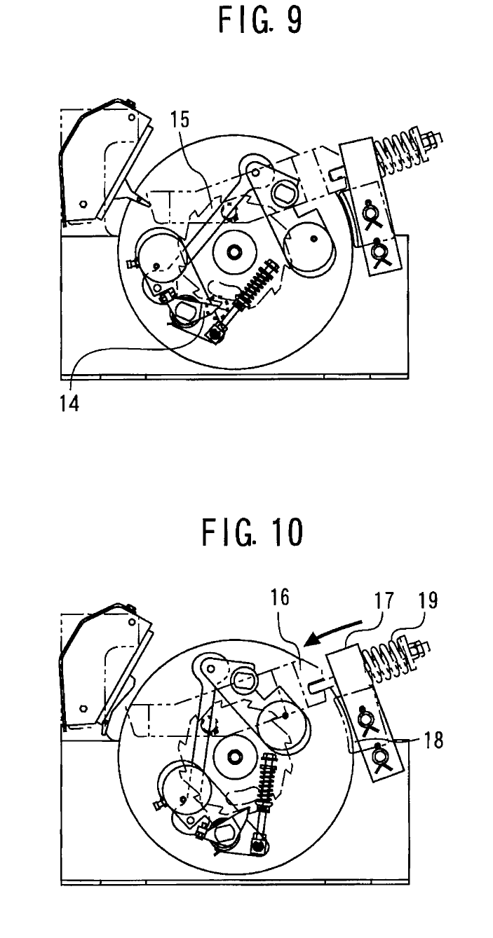

Because now it is supposed that the running direction of the car 2 is the descent direction, the engaging click 14 and the ratchet 15 engage with each other (FIG. 9, in particular, the portion surrounded in a circle with a broken line) and the ratchet 15 rotates with the sheave 8. And as a result of this rotation of the ratchet 15, the stretch rod 16 moves, the shoe lever 17 is drawn, and the shoe 18 is pushed by the shoe spring 19 against the governor rope 10 (FIG. 10).

When in this manner, the governor rope 10 is grasped by the shoe 18 and the sheave 8, the circulating movement of the governor rope 10 is constrained, an emergency stop device provided in the car 2, which is not shown, comes into action, and the car 2 is stopped.

This emergency stop device provided in the car 2 can be configured by applying previously known techniques. For example, the emergency stop device is configured to come into action in the case where the governor rope 10 is pulled up with respect to the car 2, and grasps a guide rail (not shown) of the car 2, thereby stopping the car 2.

The foregoing is the overspeed detection action of the governor 7 during a run of the car 2.

Next, actions of the elevator governor thus configured, which are performed when the elevator door is open, will be described with reference to FIGS. 11 to 14. As with the above drawings, also in these drawings, in consideration of the ease with which the drawings are seen, reference numerals of components are omitted. In these drawings, the lower diagrams were drawn from the same point of sight as the point of sight of FIG. 4, and the upper diagrams were drawn from the same point of sight as the point of sight of arrow A of FIG. 4, i.e., the point of sight of FIG. 5.

First, when the car door 2a is open, the energization of the solenoid coil 23 is cut off and the cam 21 is pushed by the push spring 22 and is disposed in the protruding position (i.e., to the sheave 8 side) (FIG. 11). As a matter of course, the car 2 is at a standstill.

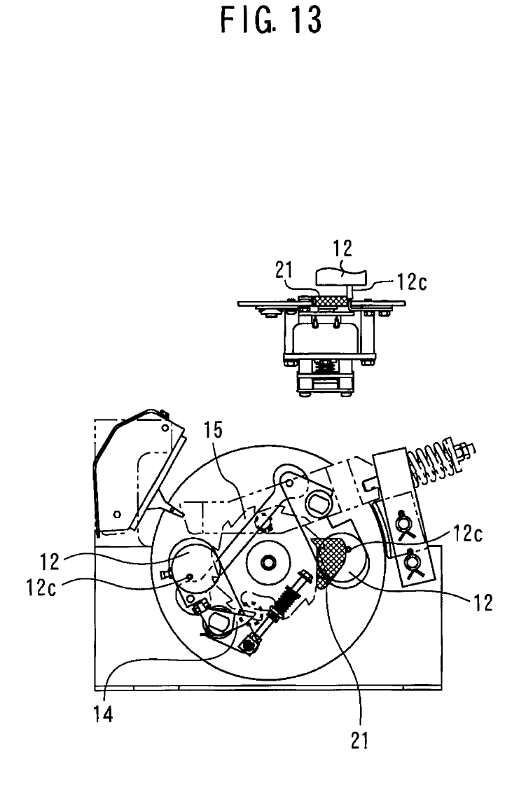

Let us assume that in this condition, the car 2 has begun to descend, with the car door 2a kept open, because of an unintended factor, for example, an abnormality in the brake of the traction machine 6. Then, the pendulum 12 begins to rotate integrally with the sheave 8 in the direction in which the car 2 descends. The pin 12c of the pendulum 12, which rotates in the direction in which the car 2 descends, comes into contact with the cam 21 in the protruding position, and is guided by the cam surface of the cam 21, with the result that the pendulum 12 is caused to swing forcedly to the radially outer side of the sheave 8 (FIG. 12).

When the car 2 descends further and the rotation of the sheave 8 and the pendulum 12 continue, the pendulum 12 is caused by the cam 21 to move further to the radially outer side of the sheave 8 and the engaging click 14 of the pendulum 12 comes into contact with the ratchet 15.

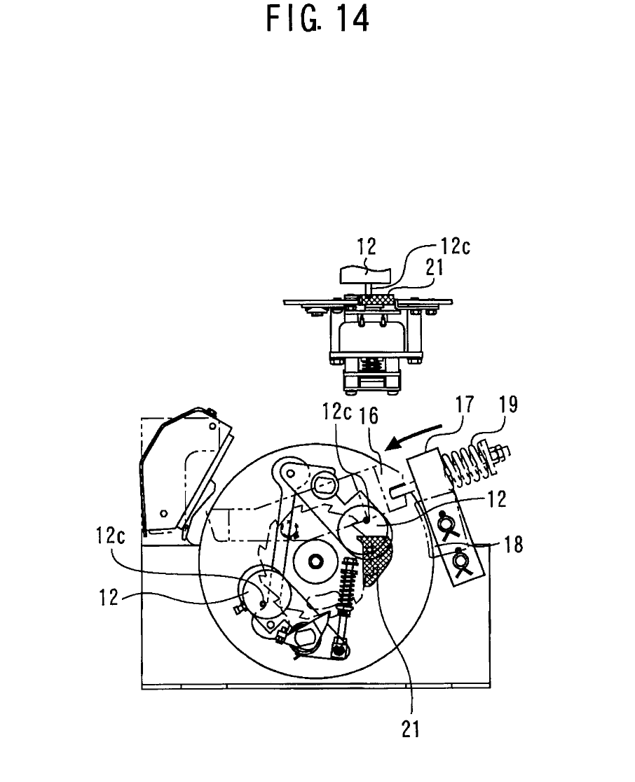

Because now the car 2 is descending, the engaging click 14 and the ratchet 15 engage with each other (FIG. 13, in particular, the portion surrounded in a circle with a broken line) and the ratchet 15 rotates with the sheave 8. And as a result of this rotation of the ratchet 15, the stretch rod 16 moves, the shoe lever 17 is drawn, and the shoe 18 is pushed by the shoe spring 19 against the governor rope 10 (FIG. 14).

When in this manner, the governor rope 10 is grasped by the shoe 18 and the sheave 8, the circulating movement of the governor rope 10 is constrained, and an emergency stop device provided in the car 2, which is not shown, comes into action, as in the same manner as the above-described case where the governor 7 detected an overspeed of the car 2 during a run of the car 2.

As described above, in the case where the car 2 has begun an unintended descent, with the car door 2a kept open, regardless of the descent speed of the car 2, a condition similar to the case where an overspeed of the car 2 was detected is produced in the governor 7, whereby it is possible to actuate the emergency stop device.

In the foregoing, the description was given by supposing the case where, in the process in which the cam 21 is moved from the retracted position to the protruding position, the pendulum 12 is present in the position where the cam 21 and the pin 12c of the pendulum 12 do not interfere or come contact with each other. However, in what rotational position the sheave 8 stops when the car 2 stopped, can vary. Therefore, when the car 2 stopped, the pendulum 12 may sometimes be disposed in a position where the cam 21 comes into contact with the pin 12c in the process of movement if nothing is performed.

Actions of the governor 7 in this case will be described with reference to FIGS. 15 and 16. As described above, the movement of the cam 21 from the retracted position to the protruding position is performed by the urging by the push spring 22 to the protruding position. Therefore, in the case where the cam 21 and the pin 12c are, for example, in a positional relationship as shown in FIG. 15, the cam 21 in the process of movement to the protruding position abuts against the tip of the pin 12c and is prevented from moving to the protruding position (FIG. 16).

When in this condition the car 2 descends and the sheave 8 rotates, also the pendulum 12 and the pin 12c move, the contact between the pin 12c and the cam 21 becomes loose, the cam 21 is moved by the urging force of the push spring 22 to the protruding position, and the condition of FIG. 11 is produced. And when the sheave 8 rotates approximately halfway around, the pin 12c of the other pendulum 12 is guided by the cam surface of the cam 21, with the result that the pendulum 12 is caused to swing forcedly to radially outer side of the sheave 8.

Because as described above, the moving direction of the cam 21 is substantially perpendicular to the side surface of the sheave 8, even when the cam 21 and the pin 12c come into contact with each other in the process of movement of the cam 21, the pendulum 12 will not be moved to the radially outer side of the sheave 8. Therefore, even when the cam 21 which is moved to the protruding position and the pin 12c are in a positional relationship in which the two come into contact with each other when the car 2 stopped, the pendulum 12 will not be moved to the radially outer side of the sheave 8 over a moving distance which is not less than a predetermined moving distance, and it is possible to avoid the condition in which the emergency stop device is instantaneously actuated by the descent of the car 2.

By appropriately changing the shape of the cam 21 and the arrangement of the pin 12c, it is possible to adjust the amount of rotation of the sheave 8 which is required for that the pin 12c is guided to the cam surface of the cam 21 present in the protruding position and that the engaging click 14 engages with the ratchet 15.

And for the amount of rotation of the sheave 8, in order to adapt to the amount of descent of the car 2, by setting the amount of descent of the car 2, which is required until the emergency stop device comes into action when the car door 2a is open, at a value larger than the amount of descent of the car 2 to such an extent that can usually occur when a user boards a car, it is possible to appropriately actuate the emergency stop device in the event of occurrence of an unintended descent of the car 2, with the car door 2a kept open, while preventing malfunctions of the emergency stop device.

For example, it is ensured that the distance along the surface of the cam surface of the cam 21 is set at a distance which is not less than a predetermined distance determined on the basis of a minimum value of the amount of descent of the car 2 in which the emergency stop device is actuated in the case where the car 2 descends when the car door 2a is open, i.e., a minimum value of the amount of descent to be allowed for the car 2 when the car door 2a is open. By performing like this, it is possible to make the above-described minimum amount of descent larger than the amount of sinking of the car to such an extent that can usually occur when a user boards a car, and it is possible to appropriately actuate the emergency stop device by preventing malfunctions of the emergency stop device in the case where a descent of the car occurs when the door is open.

Here, the description was given of the case where the cam 21 is moved along a direction substantially perpendicular to the side surface of the sheave 8. However, this direction of movement of the cam 21 to the protruding place is not limited to a direction along a direction substantially perpendicular to the side surface of the sheave 8. That is, in the process of movement of the cam 21, the cam 21 may be moved from the direction in which the pin 12c and the pendulum 12 are not moved to the radially outer side of the sheave 8 to the protruding position. For example, the cam 21 may be moved to the protruding position along a direction inward from the radially outer side of the sheave 8.

Although the pin 12c is provided as a member guided by the cam 21 in order to spread the pendulum 12 to the radially outward direction of the sheave 8, in place of this pin 12c the cam 21 may directly guide part of the pendulum 12 (the cam contact portion).

In the foregoing, the description was given of the configuration in which in the case where the car descends when the car door is open, the descent of the car is stopped by actuating the emergency stop device provided in the car. In this connection, furthermore, when the car door is open the descent of the counterweight is detected by a governor for the counterweight and an emergency stop device provided in the counterweight is actuated and the descent of the counterweight is stopped, whereby it is possible to indirectly stop also the ascent of the car.

However, it is in the case of a traction type elevator which has described above that like this, it is necessary to stop also the ascent of the car when the door is open. The elevator governor thus configured can be applied not only to a traction type elevator, but also to a drum type elevator. And in a drum type elevator, for example, even when troubles of the brake of the traction machine occur, the car will not ascend. Therefore, in a drum type elevator, all that is needed is that only the descent of the car is stopped through the use of a governor for the car.

The elevator governor configured as described above is an elevator governor which has a governor rope which performs circulating movement in synchronization with ascent and descent of a car disposed in a shaft of an elevator in such a manner as to be capable of ascending and descending and a sheave on which the governor rope is wound and which rotates in synchronization with the ascent and descent of the car via the governor rope, and constrains the circulating movement of the governor rope in a case when the descent speed of the car has reached a predetermined speed. This elevator governor includes: a pendulum which is provided in the sheave, rotates integrally with the sheave, and moves to a radially outer side of the sheave according to the rotational speed of the sheave; rope constraining means which constrains the circulating movement of the governor rope when the pendulum has moved over a moving distance which is not less than a predetermined moving distance to the radially outer side of the sheave when the car is descending; a cam contact portion which is provided in the pendulum and moves integrally with the pendulum with respect to the sheave; a cam which is provided in such a manner as to be capable of moving between a protruding position where the cam can come into contact with the cam contact portion and a retracted position where the cam cannot come into contact with the cam contact portion; and cam moving means which moves the cam from the retracted position to the protruding position when the car door is open. And the cam has a cam surface which is formed in such a manner that, in the case where the cam is in the protruding position, the cam surface guides the cam contact portion of the pendulum which rotates integrally with the sheave in the direction in which the car descends, and moves the pendulum to the radially outer side of the sheave over a moving distance which is not less than the predetermined moving distance. The cam moving means moves the cam from the direction in which the cam contact portion and the pendulum are not moved to the radially outer side of the sheave to the protruding position in the process of movement of the cam.

For this reason, for the amount of descent of the car in the period until the emergency stop device comes into action in the case where the descent of the car occurs when the door is open, it is possible to ensure a minimum amount of descent which is not zero, and it is possible to appropriately actuate the emergency stop device by preventing malfunctions of the emergency stop device in the case where the descent of the car occurs when the door is open.

The cam moving means is provided with a push spring as an elastic body which urges the cam in the direction in which the cam is moved to the protruding position, and a solenoid coil which moves the cam from the protruding position to the retracted position, when energized.

As a result of this, it is possible to easily and rapidly carry out the transition from the condition in which an unexpected descent of the car is detected and the emergency stop device is actuated to the condition in which the elevator is made capable of running.

### Embodiment 2

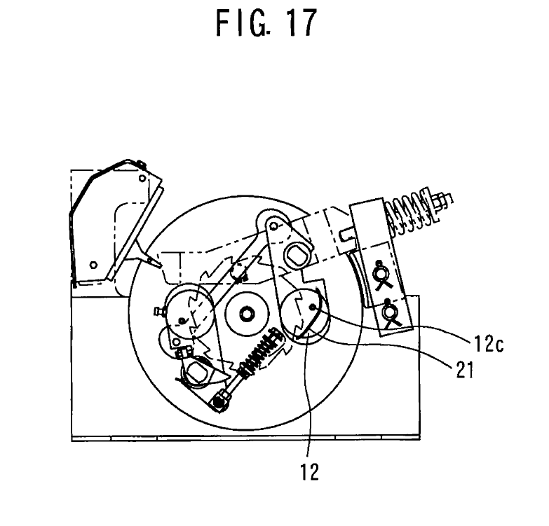

FIG. 17 relates to Embodiment 2 of the present invention and is a front view of an elevator governor in this embodiment. Embodiment 2 ensures that in the process of movement of the cam to the protruding position, interference between the pin and the cam is avoided as far as possible by forming the cam with a thinnest possible shape, with the cam surface remaining.

That is, as shown in FIG. 17, the cam 21 has a cam surface for guiding the pin 12c of the pendulum 12. And the cam 21 has a shape in which the portion except members necessary for forming this cam surface is removed as far as possible. As a matter of course, this shape of the cam 21 is adjusted in the range in which the exact rigidity required by appropriately guiding the pin 12c is ensured.

This configuration makes it possible to avoid the interference between the pin of the pendulum and the cam as far as possible in the process of moving the cam to the protruding position. Therefore, it is possible to reduce the frequency of the phenomenon that in the process of moving the cam to the protruding position when the car door is open, the cam and the pin of the pendulum come into contact with each other, with the result that the movement of the cam to the protruding position is temporarily impeded, and it is possible to reduce the frequency of occurrence of the wear of the pin and the cam and of noises of contact between the pin and the cam.

### INDUSTRIAL APPLICABILITY

The present invention can be applied to an elevator governor which has a governor rope which performs circulating movement in synchronization with the ascent and descent of a car disposed in a shaft of an elevator in such a manner as to be capable of ascending and descending and a sheave on which the governor rope is wound and which rotates in synchronization with the ascent and descent of the car via the governor rope, and constrains the circulating movement of the governor rope in the case when the descent speed of the car has reached a predetermined speed, and an elevator device provided with such an elevator governor.

### DESCRIPTION OF SYMBOLS

1 shaft
2 car
2a car door
2b arm portion
3 main rope
4 counterweight
5 machine room
5a control panel
6 traction machine
7 governor
8 sheave
8a sheave shaft
9 governor tension sheave
10 governor rope
11 frame
12 pendulum
12a pendulum shaft
12b link rod
12c pin
13 pendulum spring
14 engaging click
15 ratchet
16 stretch rod
16a attaching shaft
17 shoe lever
18 shoe
19 shoe spring
20 overspeed switch
20a switch lever
21 cam
22 push spring
23 solenoid coil
24 spring holding plate
25 solenoid plunger

1. An elevator governor which has a governor rope which performs circulating movement in synchronization with ascent and descent of a car disposed in a shaft of an elevator in such a manner as to be capable of ascending and descending and a sheave on which the governor rope is wound and which rotates in synchronization with the ascent and descent of the car via the governor rope, and constrains the circulating movement of the governor rope in a case when the descent speed of the car has reached a predetermined speed, comprising:
a pendulum which is provided in the sheave, rotates integrally with the sheave, and moves to a radially outer side of the sheave according to the rotational speed of the sheave;
rope constraining means which constrains the circulating movement of the governor rope when the pendulum has moved over a moving distance which is not less than a predetermined moving distance to the radially outer side of the sheave when the car is descending;
a cam contact portion which is provided in the pendulum and moves integrally with the pendulum with respect to the sheave;
a cam which is provided in such a manner as to be capable of moving between a protruding position where the cam can come into contact with the cam contact portion and a retracted position where the cam cannot come into contact with the cam contact portion; and
cam moving means which moves the cam from the retracted position to the protruding position when the car door is open,
wherein the cam has a cam surface which is formed in such a manner that, in the case where the cam is in the protruding position, the cam surface guides the cam contact portion of the pendulum which rotates integrally with the sheave in the direction in which the car descends, and moves the pendulum to the radially outer side of the sheave over a moving distance which is not less than the predetermined moving distance, and
wherein the cam moving means moves the cam to the protruding position from the direction in which the cam contact portion and the pendulum are not moved to the radially outer side of the sheave in the process of movement of the cam.

2. The elevator governor according to claim 1, wherein the cam moving means moves the cam along a direction substantially perpendicular to a side surface of the sheave between the protruding position and the retracted position, and
wherein the cam contact portion is provided substantially perpendicular to the side surface of the sheave.

3. The elevator governor according to claim 1, wherein the cam moving means moves the cam along a direction inward from the radially outer side of the sheave between the protruding position and the retracted position, and
wherein the cam contact portion is provided substantially perpendicular to the side surface of the sheave.

4-7. (canceled)

8. The elevator governor according to claim 1, wherein the cam moving means is provided with an elastic body which urges the cam in the direction in which the cam is moved to the protruding position, and
wherein the cam is prevented by the cam contact portion from moving to the protruding position in the case where in the process of movement, the cam comes into contact with the cam contact portion.

9. The elevator governor according to claim 2, wherein the cam moving means is provided with an elastic body which urges the cam in the direction in which the cam is moved to the protruding position, and
wherein the cam is prevented by the cam contact portion from moving to the protruding position in the case where in the process of movement, the cam comes into contact with the cam contact portion.

10. The elevator governor according to claim 3, wherein the cam moving means is provided with an elastic body which urges the cam in the direction in which the cam is moved to the protruding position, and
wherein the cam is prevented by the cam contact portion from moving to the protruding position in the case where in the process of movement, the cam comes into contact with the cam contact portion.

11. The elevator governor according to claim 8, wherein the cam moving means is provided with a solenoid coil which moves the cam from the protruding position to the retracted position, when energized.

12. The elevator governor according to claim 9, wherein the cam moving means is provided with a solenoid coil which moves the cam from the protruding position to the retracted position, when energized.

13. The elevator governor according to claim 10, wherein the cam moving means is provided with a solenoid coil which moves the cam from the protruding position to the retracted position, when energized.

14. The elevator governor according to claim 1, wherein a distance along a surface of the cam surface is set at a distance which is not less than a predetermined distance determined on the basis of a minimum value of the amount of descent to be allowed for the car when the car door is open.

15. The elevator governor according to claim 2, wherein a distance along a surface of the cam surface is set at a distance which is not less than a predetermined distance determined on the basis of a minimum value of the amount of descent to be allowed for the car when the car door is open.

16. The elevator governor according to claim 3, wherein a distance along a surface of the cam surface is set at a distance which is not less than a predetermined distance determined on the basis of a minimum value of the amount of descent to be allowed for the car when the car door is open.

17. An elevator device, comprising:
the elevator governor according to claim 1; and
an emergency stop device which is provided in the car and stops the car by coming into action in a case where the governor rope is pulled up with respect to the car.

18. An elevator device, comprising:
the elevator governor according to claim 2; and
an emergency stop device which is provided in the car and stops the car by coming into action in a case where the governor rope is pulled up with respect to the car.

19. An elevator device, comprising:
the elevator governor according to claim 3; and
an emergency stop device which is provided in the car and stops the car by coming into action in a case where the governor rope is pulled up with respect to the car.
